(19) United States
(12) Patent Application Publication
(10) Pub. No.: US 2013/0119669 A1
(43) Pub. Date: May 16, 2013

(54) METHOD AND DEVICE FOR HARVESTING ENERGY FROM FLUID FLOW

(71) Applicant: Zachary Murphree, Salt Lake City, UT (US)

(72) Inventor: Zachary Murphree, Salt Lake City, UT (US)

(73) Assignee: OSCILLA POWER INC., Salt Lake City, UT (US)

(21) Appl. No.: 13/463,719

(22) Filed: May 3, 2012

Related U.S. Application Data
(63) Continuation-in-part of application No. 13/333,173, filed on Dec. 21, 2011.
(60) Provisional application No. 61/425,753, filed on Dec. 21, 2010.
(60) Provisional application No. 61/482,146, filed on May 3, 2011.
(60) Provisional application No. 61/482,152, filed on May 3, 2011.
(60) Provisional application No. 61/526,640, filed on Aug. 23, 2011.
(60) Provisional application No. 61/545,448, filed on Oct. 10, 2011.

(51) Int. Cl. F03B 13/10

(52) U.S. Cl. 290/54

(57) ABSTRACT

Embodiments described herein relate to a method and device for harvesting energy from a fluid flow by converting the kinetic energy of the flow into vibrational energy, which then may be converted to electrical energy by a magnetostrictive-based vibrational energy harvester. Some embodiments of this device rely on the principle of vortex-induced vibrations, where the frequency of the induced vibration is of the same order as the frequency of vortex shedding (the Strouhal number). Some embodiments of this device rely on the principle of turbulence-induced vibration, where the frequency of vibration can be significantly higher than the vortex shedding frequency, and is related to the turbulence frequency of the flow. Some embodiments also relate to converting energy from pressure pulses or differentials in the fluid. These embodiments in no way limit the vibration induction mechanism, and other principles of flow-induced vibration may be used in conjunction with the magnetostrictive-based vibrational energy harvester.

### CROSS-REFERENCE TO RELATED APPLICATIONS

This application is a continuation-in-part of U.S. patent application Ser. No. 13/333,173, filed on Dec. 21, 2011, (docket no. OSC-P007), which claims the benefit of U.S. Provisional Application No. 61/425,753, filed on Dec. 21, 2010, (docket no. OSC-P007P) and U.S. Provisional Application No. 61/482,146, filed on May 3, 2011, (docket no. OSC-P009P). This application also claims the benefit of U.S. Provisional Application No. 61/482,152, filed on May 3, 2011, (docket no. OSC-P010P). This application also claims the benefit of U.S. Provisional Application No. 61/526,640, filed on Aug. 23, 2011, (docket no. OSC-P012P). This application also claims the benefit of U.S. Provisional Application No. 61/545,448, filed on Oct. 10, 2011, (docket no. OSC-P013P). Each of these applications is incorporated by reference herein in its entirety.

### BACKGROUND

Various techniques have been used for converting the energy of a flowing fluid to useful electrical energy. These range in scale from the multi-Megawatt generators to sub-microwatt MEMS based devices. The basic principle is to convert the kinetic energy of the fluid into motion of the energy harvester, and then use a mechanical to electrical conversion mechanism to produce useful electrical power. Many of the applications for smaller-scale (sub-kilowatt) power production preclude the use of rotating machinery commonly used in larger-scale applications due to a number of factors, including inaccessibility for maintenance and harsh operational environments. Due to these limitations, there has been an increase in interest in energy harvesters that can take energy inputs such as fluid flow or pressure differentials to generate electric power. These harvesters convert the energy of the fluid into an oscillatory displacements or load changes of some part of the harvester, which then converts these displacements or load changes to electrical energy. The literature has many instances of using electromagnetic or piezoelectric energy conversion mechanisms. While viable for very small scale power production, both of these approaches have specific difficulties in scaling up to power levels of 0.1 W or above, and more specifically 1 W or above, especially if such power production is to be maintained across a wide range of vibration frequencies.

Moving magnet designs depend on significant relative motion to be able to produce significant power. At the high frequency (about 10-500 Hz), which represents moderate acceleration (about 1-10 G's) vibration environment typical of many types of machinery, the high displacements needed to make watts (i.e., one watt or more) of power are difficult to achieve in moving magnet designs. Further, if more powerful magnets are used to increase power density, cogging forces/torques become difficult to overcome and structural stiffness requirements become exceedingly more demanding.

Piezoelectrics, being semiconducting ceramics, have intrinsic issues related to high internal resistance and/or high internal impedance, and low structural reliability that prevent them from being usefully scaled up for broad band power generation of the order of even watts (i.e., one watt or more) and have thus been largely limited to the micro-watt to milli-watt ranges.

Vortex-induced Vibration energy harvesting has been explored with both electromagnetic and piezoelectric generators. The underlying principle is that at certain flow conditions, a bluff body in a flow will have localized flow separation at one or more locations in the fluid-body interface. This leads to the development of a shear layer, where vortices form. In the wake of a bluff body, there is a feedback mechanism that causes an interaction between the shear layers, which results in the formation of a von Karman vortex street. The vortex shedding produces forces on the bluff body and pressure gradients in the vortex street, both of which can be used in conjunction with an energy harvester to produce electrical energy.

Turbulence-induced vibration does not require vortex shedding, and instead relies on the unsteadiness of turbulent flow to produce vibrations. Because turbulence generally has energy content at frequencies much higher than those produced by vortex shedding, an energy harvester using turbulence-induced vibration can operate at a much higher frequency, which is desirable because the natural frequencies of small energy harvesting devices are generally high, owing to their inherently high structural stiffness and relatively small inertial masses.

Other types of flow-induced vibration also exist, and these could be used to produce vibrations necessary to drive an energy harvester. These include gallop, flutter, root-fin interactions, shock-wave/boundary-layer interactions, cavitation, and others.

### SUMMARY

Embodiments described herein relate to a method and device for harvesting energy from a fluid flow by converting the kinetic energy of the flow into vibrational energy, which then may be converted to electrical energy by a magnetostrictive-based vibrational energy harvester. Some embodiments of this device rely on the principle of vortex-induced vibrations, where the frequency of the induced vibration is of the same order as the frequency of vortex shedding (the Strouhal number). Some embodiments of this device rely on the principle of turbulence-induced vibration, where the frequency of vibration can be significantly higher than the vortex shedding frequency, and is related to the turbulence frequency of the flow. Some embodiments also relate to converting energy from pressure pulses or differentials in the fluid. These embodiments in no way limit the vibration induction mechanism, and other principles of flow-induced vibration may be used in conjunction with the magnetostrictive-based vibrational energy harvester.

Embodiments of an apparatus are described. In one embodiment, the apparatus is an electrical generation device for electrical energy production. The electrical generation device includes a bluff body and a magnetostrictive element. The bluff body is configured to be disposed in a fluid flow. The magnetostrictive element is configured to be disposed relative to the bluff body to be subject to vibrational movement or turbulence resulting from fluid flow around the bluff body. The bluff body has physical dimensions to substantially oscillate in response to natural movement of the fluid flow, and oscillations of the bluff body result in a force on the magnetostrictive element. Other embodiments of the apparatus are also described.

Embodiments of a system are also described. In one embodiment, the system includes an enclosure and an energy generation device. The enclosure defines an interior fluid channel from an inlet to an outlet. The enclosure directs a fluid flow from the inlet to the outlet. The energy generation device is disposed within the channel of the enclosure. The energy generation device includes an electrically conductive element to induce electrical energy in response to stress on a magnetostrictive element based on a transfer of mechanical energy from the fluid flow to the magnetostrictive element. Other embodiments of the system are also described.

Embodiments of a method are also described. In one embodiment, the method is a method for electrical energy products. An embodiment of the method includes disposing a bluff body within a fluid flow. The bluff body has physical dimensions to move in response to mechanical energy of the fluid flow. The method also includes disposing a magnetostrictive element relative to the bluff body within the fluid flow. The magnetostrictive element moves in response to movement of the bluff body. The method also includes inducing electrical energy in an electrically conductive element disposed within a vicinity of the magnetostrictive element. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1A depicts a diagram of one embodiment of an energy generation device having a bluff body supported by a cantilever beam assembly.

FIG. 1B depicts an enlarged detail view of the fixed end of the cantilever beam assembly of FIG. 1A.

FIG. 1C depicts a perspective view of the energy generation device of FIG. 1A.

FIG. 2 depicts a graphical diagram of deflection and power generation as a function of frequency for an embodiment of the energy generation device of FIG. 1A.

FIG. 3A depicts a schematic diagram of a cutaway view of one embodiment of an energy generation assembly with multiple energy generation devices deployed in combination.

FIG. 3B depicts a perspective view of the energy generation assembly of FIG. 3A.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments may be used for power generation from a variety of fluid flows, including rivers/currents, exhaust flow from combustion engines, fluid flow during drilling of wells for oil and gas or geothermal applications, oil flow in completed production oil/gas wells, air/water flow around moving bodies such as ships/boats or air planes. The power produced may be large (e.g. utility scale) or small (e.g. micro-watts for trickle charging batteries), and embodiments of this invention may be scaled up or down to meet specific power requirements. The choice of a particular structure to generate a particular type of flow- or turbulence-induced vibration in no way limits the scope of this invention. The utilization of this invention for any particular application in no way limits the scope of this invention.

There are many different applications where an effective flow-induced vibration energy harvester that may generate a relatively small amount of electric power of the order of micro-Watts to a few tens of Watts would prove extremely useful. A number of these applications may occur where remote sensing is used, and where battery replacement would be cost-prohibitive. The power generated by these devices may be used to power sensing equipment or associated electronic components, or may be able to trickle charge rechargeable batteries to extend the time between recharging of these batteries. Many remote sensors not only monitor a certain parameter, but also relay this data wirelessly, and are expected to do so for multiple years. Some examples of potential applications for these harvesters include infrastructure monitoring of bridges and buildings; river and stream hydrology, including depth, flow rate, and water quality monitoring; water supply, storm water and wastewater system monitoring; downhole power production using drilling circulating fluid (e.g. “drilling mud”); intelligent well monitoring with production fluids (oil and gas); petroleum refinement and chemical processes remote monitoring; etc. Mention of these specific applications is in no way intended to limit the scope of potential applications for this invention.

An alternative to directly harvesting the kinetic energy present in flow vibrations is to harvest potential energy contained in the fluid pressure. These pressure changes can be used to deform a body in the fluid or induce motion, which can then be converted into electrical energy. This concept has marked potential because the pressure fluctuations do not have to be inherent to the flow or induced in the flow, but can be fluctuations imposed on the flow by an external source. Such pressure fluctuations may be induced specifically for the purpose of generating electrical energy using the energy harvesters, and using this energy to achieve a secondary purpose such as opening or closing a valve or just recharging batteries. In the example of pipe flow, a change in the downstream boundary condition, such as the throttling of a valve, can impose pressure fluctuations through the length of the flow, which could then be converted into useful electrical energy.

There are a number of potential applications specifically related to downhole power generation for which the energy harvesters described here can be used for. The applications can potentially reduce operator's costs, increase reliability and allow for applications currently considered impossible. Downhole power generation could be deployed in non-“smart” completions to provide power for measurements of downhole conditions (typically just pressure and temperature) and telemetry systems, thereby avoiding costly interventions that are expensive, especially on subsea wells (c. $10 million, significantly more in ultra-deep water). The power generation could eliminate the need for electric or fiber-optic cable, which can be time-consuming and expensive to install (typical additional cost of running the cable—$100,000-$200,000). “Smart” completions offer more potential deployment locations, as power is needed not only for the sensors and telemetry, but also to control the production from each interval of the completion. Currently, many of the valves that control the production are hydraulic or electro-hydraulic, but all-electric valves do exist, and the ability to meet the power requirements of these valves without running wires or relying on batteries could greatly accelerate their adoption. Additionally, a downhole power source could eliminate the need for “wet-connection” of wires between the smart completion and the upper completion. Wet connections introduce a reliability concern and are avoided whenever possible.

The specific combination of downhole power generation with downhole gauges has many advantages:
a. Significantly reduced installation costs (no cable to run)
b. The ability to position the gauge where it is optimum. This could be in the lower completion (e.g. beside screens) rather than higher up the well above the packer. The closer the data point is to the reservoir, the better quality the data would be. The purpose of the gauge is to avoid the error-prone extrapolation of surface pressure to downhole conditions with multiphase flow. Penetrations and wet-connects are complications and potential interferences with good reliability. Some completion types are virtually impossible to connect to with a wire—multilaterals being a significant class of wells like this.
c. Ability to retrofit gauges into an existing well. This would be a through tubing application and very different to the permanent application considered above. Such an application could allow a gauge to be positioned anywhere in the well but would provide a significant restriction to flow but in doing so could directly take advantage of the flow.

Clearly any sensor needs to be integrated with a data transmission route. Existing technology is available through pressure pulse telemetry by creating a temporary restriction in the production flow. This method is common in drilling applications (mud pulse telemetry). A better method is radio transmission (no restriction to flow). Downhole power generation (and long-life rechargeable batteries) would significantly enhance this technology to permanent completions.

Downhole power generation could also be a key enabling technology for “smart gas lift” applications. A power source would allow for data acquisition and transmission to the surface of the conditions at the valve, and would also allow for the variation of the valve orifice, which would promote stable flow between the annulus and the tubing. This application could take advantage of the high flow velocities through the valve as well as in-line vibration (power generation directly in the flow path).

The device could also provide a power source for isolation and clean-up valves. As an example, these valves are deployed inside a completion to act as a deep-set barrier to allow the upper completion to be recovered. The limitation of this configuration is often battery life, and a power source that could provide trickle charging to the valve control could greatly extend the capabilities of these valves. Additionally, the power source could also allow for data to be collected at the valve and transmitted to the surface (or stored for later mechanical retrieval).

Another potential application for the downhole power source is in horizontal well stimulation. These wells currently have the ability to stimulate production through opening of valves, but there are no options to close an interval as there are with a smart well. This device would allow for the remote opening and closing of these valves to facilitate re-stimulation, and would alleviate limitations on the number of valves in a well.

Embodiments herein include at least one structure designed to oscillate or vibrate when in the presence of a flowing fluid. These induced oscillations and/or vibrations are then used to generate electricity from a magnetostrictive-based vibration energy harvester. The device may include at least one magnetostrictive element and one or more electrically conductive coils or circuits. The device may also include one or more magnetic circuits which are coupled with one or more electrical circuits to increase or maximize power production. The flow-induced vibrations cause a forced oscillation response in the device, and this oscillation causes stress and strain in the magnetostrictive elements, which may be converted into electrical energy through electromagnetic induction.

For any embodiment of this device, the fluid may be liquid, gas or a two-phase mixture. An advantage of at least one embodiment described herein is its ability to operate in flows that contain multiple phases, e.g. river flows with bio-matter, waste-water systems, and crude oil flows with waxy parrafins and condensates.

One embodiment of this device is an electric power generator for use in a fluid flow. The embodiment includes a magnetostrictive element; a coil assembly; a source of magnetomotive force (MMF), comprising permanent magnet material and/or electromagnets; and a mass assembly.

In some embodiments the power generation components of the device will be enclosed in a packaging to protect them from contact with the fluid. This enclosure may comprise a rigid enclosure or be designed to deflect with the device. The latter may be accomplished by coatings or jackets.

The magnetostrictive elements are arranged to enable mechanical and/or magnetic coupling between them. In some embodiments, the mass assembly may be mechanically coupled to the overall assembly or to the magnetostrictive elements directly. In some embodiments, the source of magnetomotive force may be magnetically coupled to the magnetostrictive member assembly. In some embodiments, the magnetostrictive elements may be electromagnetically coupled to the coil assembly.

In some embodiments, at least one magnetostrictive element may be arranged to form a cantilever beam with the fixed end rigidly attached to a supporting structure (e.g., a sidewall of a pipe, a mesh or other grating spanning at least a portion of the inner diameter of a pipe, and so forth) and the free end allowed to oscillate in response to vibration. The vibration movement alters the magnetic characteristics of the magnetostrictive elements, which may result in a change in magnetic flux flowing through a magnetic circuit including the magnetostrictive element, which causes a voltage/current to be produced in the coil assembly.

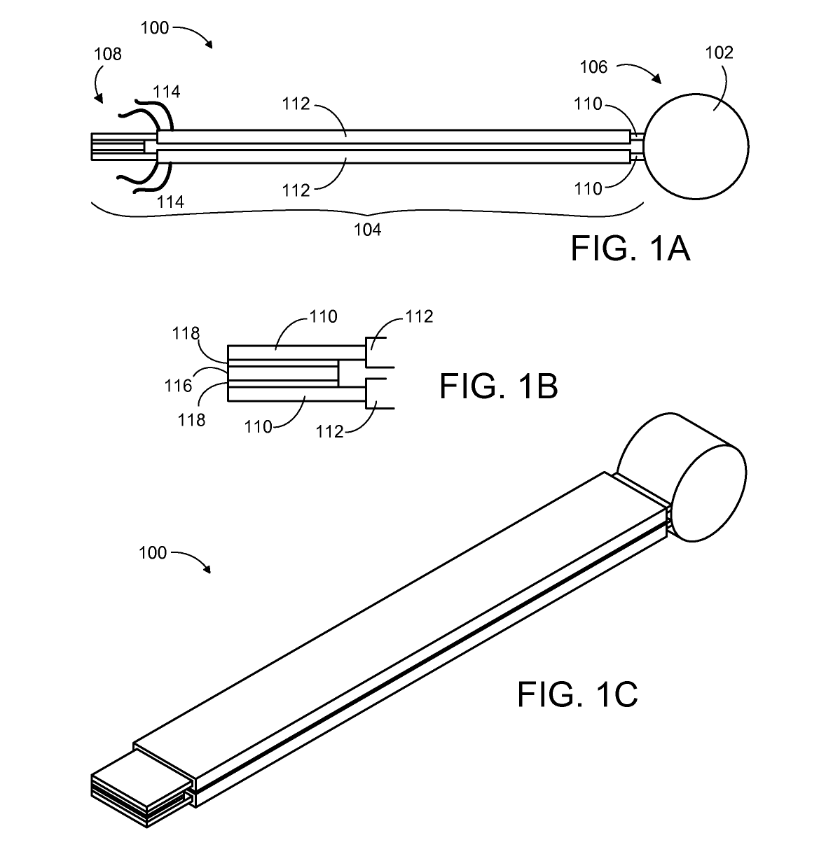

In some embodiments, the mass is configured to be a bluff body, which would produce a vortex street in a fluid flow. The structural natural frequency of the device may be tuned to match the vortex shedding frequency of the bluff body mass, thereby causing a self-excited oscillatory response to the fluid flow. An example of this embodiment is illustrated in FIGS. 1A, 1B, and 1C.

FIG. 1A depicts a diagram of one embodiment of an energy generation device 100 having a bluff body 102 supported by a cantilever beam assembly 104. The bluff body 102 may be any shape, size, and/or material suitable for generating vibrational or other oscillating motions of the cantilever beam assembly 104 when subjected to fluid flow and/or pressure.

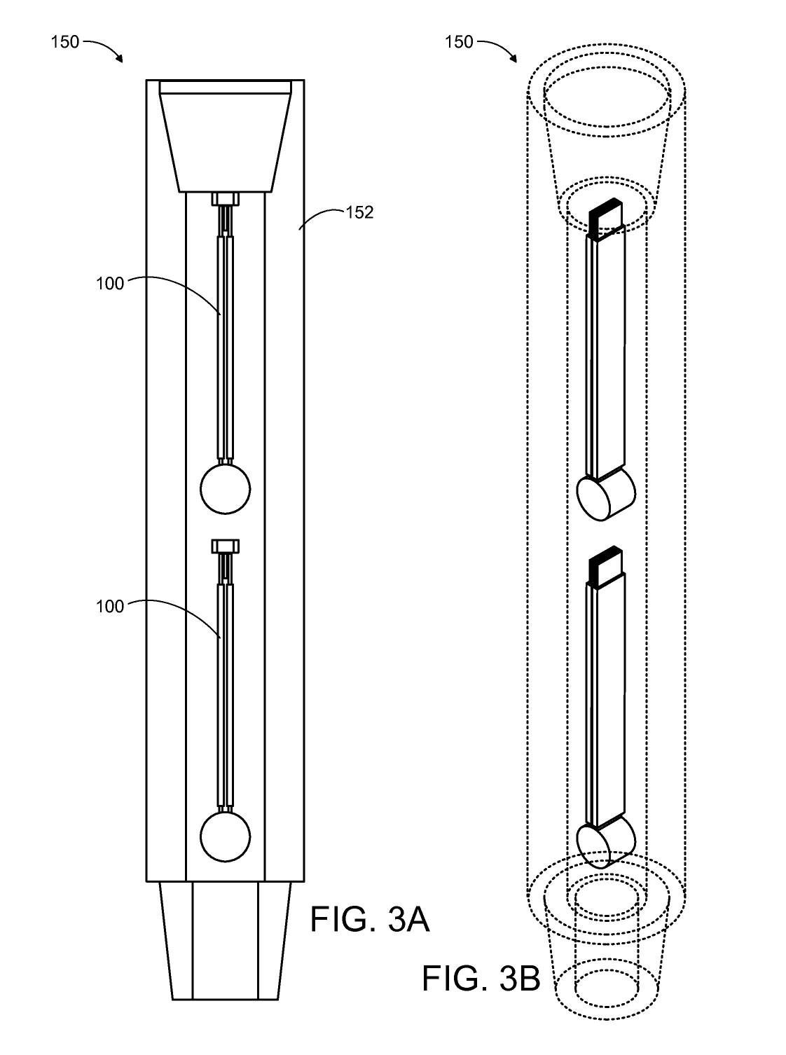

In one embodiment, the bluff body 102 is located at a free 106 end of the energy generation device 100, while the opposite end of the cantilever beam assembly 104 is at a fixed end 108 where the energy generation device 100 is attached or coupled to another structure (see FIGS. 3A and 3B). In this way, the fixed end 108 of the cantilever beam assembly 104 forms a stationary point relative to which the bluff body 102 oscillates or moves.

In the depicted embodiment, the cantilever beam assembly 104 includes a pair of magnetostrictive elements 110 that are individually enclosed in electrically conducting coils 112. Although two magnetostrictive elements 110 are shown in the depicted embodiment, other embodiments may incorporate more than two magnetostrictive elements and corresponding coils. In this arrangement, when the bluff body 102 deflects upward, the top magnetostrictive element 110 is compressed in the direction along its length, and the bottom magnetostrictive element 110 is tensed in the direction along its length. The mechanical stress induced on each of the magnetostrictive elements 110 can be converted into electrical energy which is induced in the corresponding coils 112. In the depicted configuration, the induced electrical energy is opposite (positive and negative, or vice versa) in the pair of coils 112. One or more electrical leads 114 are electrically coupled to each coil 112 in order to transfer the induced electrical energy to additional circuitry (not shown) configured to manage the electrical power transmissions.

FIG. 1B depicts an enlarged detail view of the fixed end 108 of the cantilever beam assembly 104. In one embodiment, the cantilever beam assembly 104 includes a permanent magnet 116 disposed between the magnetostrictive elements 110. The permanent magnet 116 may enhance the changes in magnetic flux and, hence, increase the amount of electrical energy that is induced in the coils 112. Insulators 118, such as an electrically insulating material, may be placed between the permanent magnet 116 and each magnetostrictive element 110. Other embodiments may include further structural elements, for example, to facilitate mounting the device 100 to another structure. Other embodiments may include further structural elements, for example, to provide pre-compression to the magnetostrictive elements. In some embodiments, more than one magnetostrictive element is configured to form a substantially closed magnetic flux path.

FIG. 1C depicts a perspective view of the energy generation device of FIG. 1A. In some embodiments, a bluff body mass may be positioned either upstream or downstream of the cantilever beam within a fluid stream.

One embodiment may include design considerations such that the bluff body is larger than the beam in the beam's transverse direction (i.e., the dimension orthogonal to the dominant vibration direction that is not along the beam axis) or may have a multitude of beams supporting the mass with at least one space between them. These considerations are taken to avoid forming a “splitter-plate” like assembly downstream of the bluff body mass, which has been shown to be an effective way of limiting the feedback mechanism in vortex-induced vibrations, thereby significantly reducing the amplitude of the vibrations.

In some embodiments, the magnetostrictive element(s) may be used to form a flexible tube-like structure that may be excited into vortex-induced vibration as fluid flows over the structure. In this embodiment, the axis of the structure is perpendicular to the flow direction, and the induced vibration is in a radial direction. An array of these structures may be placed in the flow to further excite oscillation through vortex-street impingement on downstream structures.

In another embodiment, the magnetostrictive material may be formed into a thin sheet that will oscillate in response to vortices advecting past it. These vortices may be caused by a bluff body or flow obstruction upstream of the magnetostrictive element, or may be turbulent structures inherent to the flow. As the vortices advect by, they cause a deformation of the magnetostrictive material, which leads to stresses and strains within the material. These in turn cause changes in the magnetic properties (e.g. magnetic permeability) of the element, which are then converted into electrical energy through induction. The magnetostrictive element in this particular embodiment may be completely immersed in the fluid flow, thereby forming an “eel-like” structure, or in the case of an internal flow (e.g. pipe or duct flow) may be incorporated into the structure that bounds the flow.

Another embodiment of this device is one in which the flow separation is caused by a bluff body or some other means, and the resulting vortex street impinges on a flexible structure. The structure includes a magnetostrictive energy harvester, and the fluctuations in pressure caused by the impinging vortex street lead to deformations in the magnetostrictive element(s), which are then converted into electrical energy.

Another embodiment of this device is one where pressure fluctuations inherent to the flow or imposed by an external mechanism, e.g. the throttling of a valve upstream or downstream of the device, causes the deformation of a flexible structure. The structure includes a magnetostrictive energy harvester, and the fluctuations in pressure lead to deformations in the magnetostrictive element(s), which are then converted into electrical energy. A particular embodiment of this would consist of a pipe with an inner wall that can transmit load changes to one or more magnetostrictive energy harvesters, and with the one or more magnetostrictive energy harvester disposed outside this inner wall such that pressure fluctuations would cause a change in loading of the magnetostrictive energy harvesters, which would then be converted into electrical energy. This device configuration has the advantage that the energy harvesters are clearly outside of the pipe carrying the fluid, and therefore will not be prone to any failures caused by exposure to the fluid. This is especially important in production wells where hot hydrocarbons with solid content can cause degradation and deterioration of energy harvesters that are directly in the fluid stream. It is recognized that there is an advantage to deploying the device outside of the primary flow path in downhole energy generation applications. Any restriction to the flow in a well decreases production and is generally not desirable. There is also the need to be able to perform well interventions, and the presence of a device in the primary flow path could make these necessary operations impossible. As such, all reasonable efforts should be taken to avoid deploying the energy harvester in such a way that it presents and obstruction to either the flow or well interventions.

Embodiments of such a device that utilizes pressure fluctuations may include rod based or cantilever based magnetostrictive energy harvesters. Since the fluid pressures downhole are of the order of 15,000 psi, and pressure fluctuations can be of the order of 10% of that value, rod based designs that take advantage of axial load changes in the rods may be particularly attractive from the perspective of producing power of the order of Watts, and from the perspective of high reliability. The devices may be activated by pressure pulses transmitted through the fluid medium. A variety of methods are known for transmitting pressure pulses in a fluid medium, and a particular example may be found in U.S. Pat. No. 6,970,398 specifically useful for oil wells.

Pressure fluctuations in the pipe may be transmitted to one or more magnetostrictive rods, whose permeability is a function of the stress in the magnetostrictive rod. The magnetostrictive rod or rods are part of flux paths that may comprise additional magnetically permeable components and permanent magnets. In some embodiments, the flux paths will be substantially closed with no significant air gaps. The stress changes inducted by the pressure fluctuations in the pipe will result in axial stress changes in one or more magnetostrictive elements, which will result in changes in the magnetic permeability of these elements, and therefore changes in magnetic flux density in the magnetostrictive elements and induce currents in conductive coils around the magnetostrictive elements and/or other flux path components.

As an example of a particular application, an example embodiment may be considered for use on an oil well producing 10,000 bbl/day of 35° API crude. This would equate to a mass flow rate of 15.1 kg/s, and with a dynamic viscosity of 1500 cP, the Reynolds number (Re) range based on production tubing inner diameter would range from 100 to 340 for tubing inner diameters from 1.5″ to 5″, respectively. For these Reynolds numbers, the Strouhal number (St) for a cylindrical mass has been shown to be 0.2. For a 1″ diameter mass, this means that the frequency of vortex shedding ranges from about 127 Hz for the smallest tubing diameter to about 11 Hz for the 5″ ID. These calculations are presented in Table 1.

TABLE 1
Calculation parameters.

| Tubing ID | | Pipe area | Fluid Velocity | Vortex Frequency | |
|---|---|---|---|---|---|
| (in) | (m) | (m²) | (m/s) | (Hz) | Re |
| 1.5 | 0.0381 | 0.0011 | 16.14 | 127.09 | 337.40 |
| 2 | 0.0508 | 0.0020 | 9.08 | 71.49 | 253.05 |
| 2.5 | 0.0635 | 0.0032 | 5.81 | 45.75 | 202.44 |
| 3 | 0.0762 | 0.0046 | 4.04 | 31.77 | 168.70 |
| 3.5 | 0.0889 | 0.0062 | 2.96 | 23.34 | 144.60 |
| 4 | 0.1016 | 0.0081 | 2.27 | 17.87 | 126.52 |
| 4.5 | 0.1143 | 0.0103 | 1.79 | 14.12 | 112.47 |
| 5 | 0.127 | 0.0127 | 1.45 | 11.44 | 101.22 |

Additionally, a mass with a non-circular cross section can be used to alter the Strouhal number, which will in turn change the vortex-shedding frequency. For instance, the use of a square cross section will decrease the vortex-shedding frequency by 25%, and this will also alter the amplitude of the vibrations.

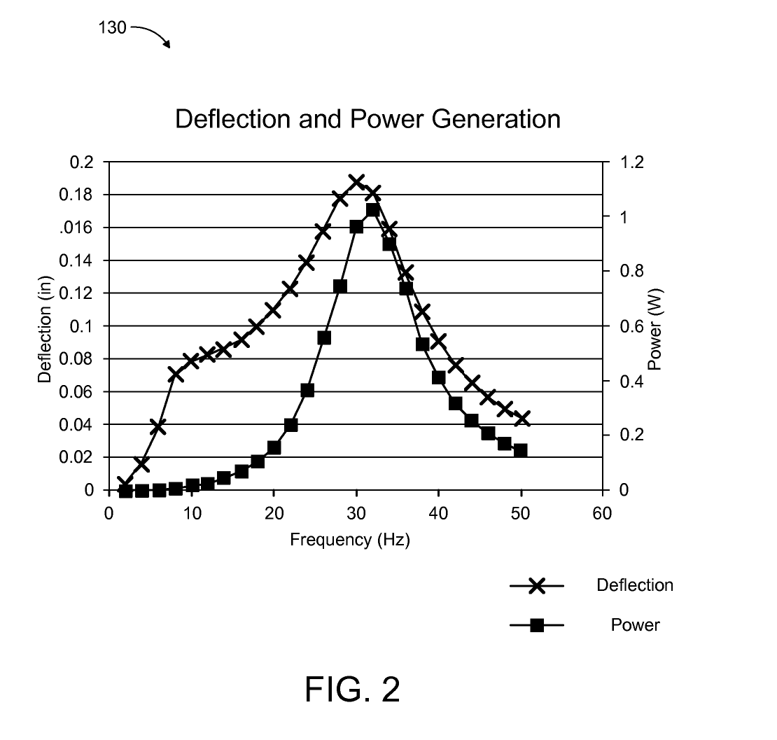

A particular embodiment might be implemented as a cantilever that is 14.7 in long, and 1.5″ wide, with each magnetostrictive element being 0.125″ thick with a 0.2″ gap between them. A 1 kg mass on the end of the cantilever would bring the natural frequency to 31.5 Hz (this assumes an added mass of 0.05 kg). This corresponds to the vortex-shedding frequency for the 3″ pipe in Table 1. If the tip deflection is about 0.2″, the power production from the cantilever is conservatively calculated to be on the order of about 1 W. This is well below the kinetic energy flux of the fluid, which is around 125 W. FIG. 2 depicts a graphical diagram 130 of deflection and power generation as a function of frequency for an embodiment of the energy generation device 100 of FIG. 1A.

The Reynolds number will increase by over two orders of magnitude if the fluid is natural gas instead of crude. This will allow for more creative use of mass shaping and other factors, as the unstable response of many shapes in vortex-induced and flutter vibrations occur more readily at higher Reynolds number. However, the Strouhal number remains fairly constant over a very large range of Re (e.g., for circular cylinders St=0.2 for Re from 102 to 105), and the vortex-induced vibrations might be expected to occur in a frequency range that is consistent with the above calculations.

In another embodiment, the turbulence of the flow itself is used to induce vibrations that cause stresses/strains in the magnetostrictive elements. This mechanism does not rely on vortex shedding, and thus has no Strouhal number dependence. The turbulence contains broadband fluctuations, and these couple into the natural frequencies of the immersed body to produce a vibrational response. While it may be advantageous in some embodiments to avoid reliance on vortex shedding, the amplitudes of turbulence induced vibration are generally smaller than those caused by vortices. A sample calculation from Blevins (Chapter 8, Turbulence-Induced Vibration in Parallel Pipe Flow) shows that a 12″×18″×0.125″ plate on the wall of a square duct with air flow at 61 m/s has a maximum deflection of 5 μm for the fundamental mode. If the plate were a beam of magnetostrictive elements, the power output for vibration at the natural frequency of 119 Hz would be on the order of about 1 mW. Compare this with the total kinetic energy flux of this flow, which is 38 kW.

Another embodiment has multiple devices deployed to increase the total power generation. Each individual device could be any one of the aforementioned embodiments, and this embodiment would allow for any combination thereof. An illustration of an embodiment comprised of two cantilever-based flow energy harvesters is illustrated in FIGS. 3A and 3B.

FIG. 3A depicts a schematic diagram of a cutaway view of one embodiment of an energy generation assembly 150 with multiple energy generation devices 100 deployed in combination. FIG. 3B depicts a perspective view of the energy generation assembly 150 of FIG. 3B. In the illustrated embodiments, the energy generation devices 100 are arranged in series within a flow enclosure 152. In general, the flow enclosure 152 directs a stream of fluid (not shown) through an interior channel within the vicinity of the energy generation devices 100. Depending on the arrangement of the devices 100 within the enclosure 152, the fluid may flow past one or more devices 100 at approximately the same time, or the fluid may flow past separate devices in series.

Additionally, the fluid may be directed to flow from the fixed end 108 of the devices 100 toward the free end 102 (as shown) or, alternatively, in the opposite direction. In some embodiments, the devices 100 within the enclosure 152 are all oriented in the same direction, either in series or parallel. In other embodiments, at least some of the devices 100 are oriented in opposite directions, with either the free end 106 or the fixed end 108 first receiving the fluid impact. In other embodiments, one or more of the devices 100 may be oriented at a non-zero angle relative to another device 100 so that there is an angular difference between two or more devices 100 within the same enclosure 152.

In further embodiment, the interior structure of the enclosure 152 may be configured to facilitate a predetermined fluid pattern within the enclosure 152. By altering the interior sidewall dimensions, angles, and other geometrical characteristics, it may be possible to enhance the vibrational movement of the energy generation devices 100 within the enclosure 152. Additionally, it may be possible to reduce eddy current effects from one device 100 that might otherwise decrease the vibrational movements of another downstream device 100.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus for electrical energy production, the apparatus comprising:
a bluff body configured to be disposed in a fluid flow; and
a magnetostrictive element configured to be disposed relative to the bluff body to be subject to vibrational movement or turbulence resulting from fluid flow around the bluff body;
wherein the bluff body has physical dimensions to substantially oscillate in response to natural movement of the fluid flow, and oscillations of the bluff body result in changes in force on the magnetostrictive element.

2. The apparatus of claim 1, wherein the oscillations of the bluff body result from vortex-induced vibrations.

3. The apparatus of claim 1, wherein the oscillations of the bluff body result from turbulence-induced vibrations.

4. The apparatus of claim 1, wherein the oscillations of the bluff body result from a pressure change in the fluid.

5. The apparatus of claim 1, further comprising a cantilever structure to which the magnetostrictive element is coupled.

6. The apparatus of claim 1, wherein the cantilever structure further comprises an electrically conductive member disposed within a vicinity of the magnetostrictive element, wherein the electrically conductive member is configured to induce electrical energy in response to a change in magnetic flux of the magnetostrictive element due to the force on the magnetostrictive element.

7. The apparatus of claim 6, wherein the magnetostrictive element forms a support member of a cantilever structure, wherein the cantilever structure is coupled to the bluff body to move in combination with oscillations of the bluff body.

8. The apparatus of claim 7, wherein more than one magnetostrictive element is coupled to the bluff body, wherein the cantilever structure further comprises a fixed end of the magnetostrictive elements that are coupled to a fixed support structure relative to the fluid flow.

9. The apparatus of claim 8, wherein the magnetostrictive elements are offset on opposite sides of an axis between the fixed end and the bluff body, wherein at least two of the magnetostrictive elements are configured to simultaneously experience opposing mechanical stresses (compression or tension) in response to the oscillations of the bluff body, and each conductive coil is configured to induce opposing electrical energy (positive or negative).

10. The apparatus of claim 6, wherein the magnetostrictive element is part of a substantially closed magnetic flux path.

11. The apparatus of claim 1, wherein the magnetostrictive element is packaged in a structure that has a substantially tubular shape.

12. A system for electrical energy production, the system comprising:
an enclosure defining an interior fluid channel from at least one inlet to at least one outlet, wherein the enclosure is configured to direct a fluid flow from the inlet to the outlet; and
an energy generation device disposed within the channel of the enclosure, wherein the energy generation device comprises an electrically conductive element configured to induce electrical energy in response to stress on a magnetostrictive element based on a transfer of mechanical energy from the fluid flow to the magnetostrictive element.

13. The system of claim 12, wherein the energy generation device further comprises a bluff body configured to be disposed in the fluid flow, wherein the bluff body has physical dimensions to substantially move in response to the mechanical energy of the fluid flow.

14. The system of claim 13, wherein the bluff body is further configured to oscillate in response to natural movement of the fluid flow, and oscillations of the bluff body result in mechanical force changes on the magnetostrictive element.

15. The system of claim 13, wherein the bluff body is coupled to the magnetostrictive element, wherein the bluff body is configured to be disposed downstream from the magnetostrictive element so that the bluff body is closer than the magnetostrictive element to the outlet of the enclosure.

16. The system of claim 13, wherein the bluff body is coupled to the magnetostrictive element, wherein the bluff body is configured to be disposed upstream from the magnetostrictive element so that the bluff body is closer than the magnetostrictive element to the inlet of the enclosure.

17. The system of claim 12, wherein the energy generation device is one a plurality of energy generation devices, wherein the plurality of energy generation devices are disposed in series within the enclosure between the inlet and the outlet.

18. A method for electrical energy production, the method comprising:
disposing a bluff body within a fluid flow, wherein the bluff body has physical dimensions to move in response to mechanical energy of the fluid flow;
disposing a magnetostrictive element relative to the bluff body within the fluid flow, wherein the magnetostrictive element is configured to experience changes in force and corresponding changes in magnetic flux in response to movement of the bluff body; and
inducing electrical energy in an electrically conductive element disposed within a vicinity of the magnetostrictive element.

19. The method of claim 18, further comprising inducing the electrical energy in the electrically conductive element in response to oscillations of the bluff body due to channeled movement of the fluid flow.

20. The method of claim 18, further comprising inducing the electrical energy in the electrically conductive element in response to movement of the bluff body due to a change in pressure of the fluid flow.
